(19) United States
(12) Patent Application Publication
(10) Pub. No.: US 2018/0096314 A1
(43) Pub. Date: Apr. 5, 2018

(54) METHOD FOR TRANSMITTING AN ELECTRONIC RECEIPT

(71) Applicant: MASTERCARD ASIA/PACIFIC PTE LTD, Singapore (SG)

(72) Inventors: Syam Sasidharan NAIR, Singapore (SG); Harjender SINGH, Singapore (SG); Michihiko YODEN, Singapore (SG); Chee Leong LIEW, Singapore (SG); Holger KUNKAT, Neumuenster (DE)

(73) Assignee: MASTERCARD ASIA/PACIFIC PTE LTD, Singapore (SG)

(21) Appl. No.: 15/715,603

(22) Filed: Sep. 26, 2017

(30) Foreign Application Priority Data
Oct. 4, 2016 (SG) 10201608323P

(51) Int. Cl. G06Q 20/04; H04L 12/58

(52) U.S. Cl. CPC G06Q 20/0453; H04L 51/10

(57) ABSTRACT

According to a first aspect of the present invention, there is provided a method for transmitting an electronic receipt from an intermediary terminal connected to a payment interface and a payment network, the method comprising: receiving, from the payment interface, transaction purchase data of purchases made via the payment interface and details of a payment instrument on which the purchases are made; transmitting, to the payment network, details of the payment instrument; receiving, from the payment network, personal detail data of an account holder of the payment instrument; generating an electronic receipt from the received transaction purchase data and the received personal detail data; and transmitting the electronic receipt to at least one electronic address, the at least one electronic address being determined from the received personal detail data.

### FIELD OF INVENTION

The present invention relates broadly to a method for transmitting an electronic receipt.

### BACKGROUND

Receipts issued after purchase of good and/or services have several purposes. They serve as proof of purchase and can be used for good exchange if the purchased good is defective or for refund if the stall purchase policy provides such a service. Such proof of purchase is also sometimes needed should a consumer wish to exercise their warranty rights. Receipts can also help the consumer keep track of their expenses.

More than one receipt may be issued at the time of payment should a customer make payment using a payment instrument like a credit card. A first receipt is issued by the payment terminal which processes the credit card, while a second receipt is issued by a cash register terminal which processes items purchased from a retail store. Although the printing of two receipts is a waste of resources, it is necessary because the first receipt typically does not provide itemised detail of the purchases made. The customer has to refer to the second receipt for this information.

In addition, printed receipts have a tendency to be misplaced. Further, printed receipts fade away over time, which makes such receipts difficult to be used when making the above warranty claim.

There is thus a need to address one or more of the above problems associated with printed receipts.

### SUMMARY

According to a first aspect of the present invention, there is provided a method for transmitting an electronic receipt from an intermediary terminal connected to a payment interface and a payment network, the method comprising: receiving, from the payment interface, transaction purchase data of purchases made via the payment interface and details of a payment instrument on which the purchases are made; transmitting, to the payment network, details of the payment instrument; receiving, from the payment network, personal detail data of an account holder of the payment instrument; generating an electronic receipt from the received transaction purchase data and the received personal detail data; and transmitting the electronic receipt to at least one electronic address, the at least one electronic address being determined from the received personal detail data.

According to a second aspect of the present invention, there is provided an intermediary terminal adapted to connect to a payment interface and a payment network, the intermediary terminal comprising: at least one processor; at least one memory including computer program code; a cashier port in electrical communication with the payment interface; a network port in electrical communication with the payment network; and a transmission port, the at least one memory and the computer program code configured to, with the at least one processor, cause the intermediary terminal at least to: receive, through the cashier port, transaction purchase data of purchases made at the payment interface and details of a payment instrument on which the purchases are made; receive, through the network port, personal detail data of an account holder of the payment instrument; generate an electronic receipt from the received transaction purchase data and the received personal detail data; and transmit, through the transmission port, an electronic receipt to at least one electronic address, the at least one electronic address being determined from the received personal detail data.

According to a third aspect of the present invention, there is provided a payment interface in electrical communication with an intermediary terminal, the intermediary terminal configured to generate and transmit an electronic receipt, the payment interface comprising: at least one processor; and at least one memory including computer program code; and a transmission port in electrical communication with the intermediary terminal, the at least one memory and the computer program code configured to, with the at least one processor, cause the payment interface at least to: detect use of a payment instrument to make purchases; generate a pairing identifier used to initiate generation of the electronic receipt of the purchases made; and transmit, through the transmission port, the pairing identifier to the intermediary terminal.

According to a fourth aspect of the present invention, there is provided a non-transitory computer readable medium having stored thereon executable instructions for controlling an intermediary terminal, adapted to connect to a payment interface and a payment network, to perform steps comprising receive, through a cashier port, transaction purchase data of purchases made via the payment interface and details of a payment instrument on which the purchases are made; transmit, through a network port, details of the payment instrument; receive, through the network port, personal detail data of an account holder of the payment instrument; generate an electronic receipt from the received transaction purchase data and the received personal detail data; and transmit, through a transmission port, an electronic receipt to at least one electronic address, the at least one electronic address being determined from the received personal detail data.

According to a fifth aspect of the present invention, there is provided a non-transitory computer readable medium having stored thereon executable instructions for controlling a payment interface, the payment interface in electrical communication with an intermediary terminal configured to generate and transmit an electronic receipt, to perform steps comprising detecting use of a payment instrument to make purchases; generating a pairing identifier used to initiate generation of the electronic receipt of the purchases made; and transmitting, through a transmission port, the pairing identifier to the intermediary terminal.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a method, in accordance with one embodiment of the invention, allowing for transmission of an electronic receipt from an intermediary terminal connected to a cashier system and a payment network.

FIG. 2 shows an overview of a system which operates in accordance with the method of FIG. 1.

FIGS. 3A and 3B show one possible implementation of the method of FIG. 1.

FIG. 4 shows the registration process of FIGS. 3A and 3B.

FIGS. 5A and 5B show a flowchart for implementing the method shown in FIG. 1.

FIG. 6 depicts an exemplary computing device used to implement the intermediary terminal described in FIG. 2.

FIG. 7 is a schematic of a computing device used to implement the payment terminal shown in FIG. 2.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a conventional computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

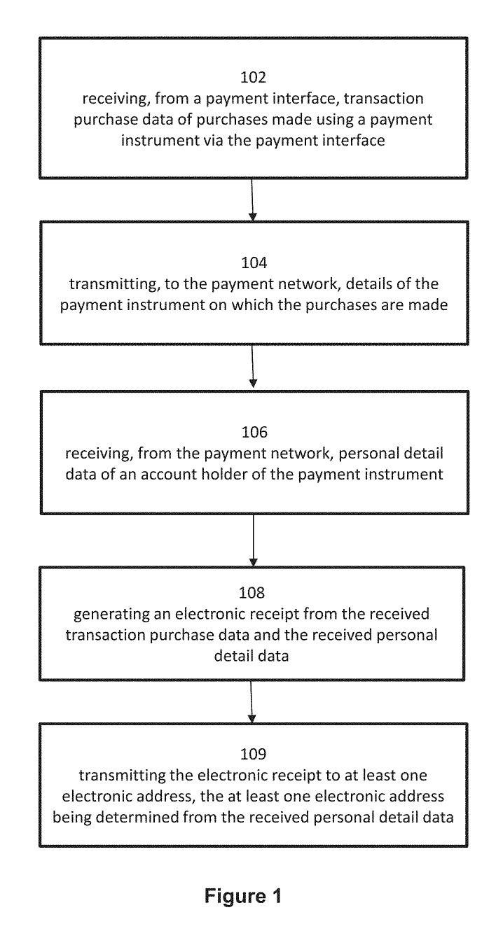

FIG. 1 shows a method 100, in accordance with one embodiment of the invention, allowing for transmission of an electronic receipt from an intermediary terminal connected to a payment interface and a payment network.

The transmission uses electrical signals to have the electronic receipt sent to one or more electronic addresses. Such an electronic receipt is thus in digital or soft copy format, as opposed to a printed receipt. The one or more electronic addresses can be accessed by an intended recipient through a computing device, like a mobile phone or a computer terminal. The intended recipient is typically an account holder of a payment instrument used to make purchases on which the electronic receipt is issued. In the disclosure below, the account holder is interchangeably referred to as a customer or cardholder.

The intermediary terminal is typically a server that may be situated in a retail store from which the purchases are made. Alternatively, the server may be remotely situated, for example, if the server is part of a computer cloud network.

The payment interface, to which the intermediary terminal is connected, may include components in a retail store that support electronic payment, such as one or more of a payment terminal and a POS (point of sale) terminal (optionally having a card reader). The payment terminal is a device that is typically used to interface with a payment instrument, such as credit, debit and stored value cards. The payment terminal may also include a NFC (Near Field Communication) transceiver that receives and transmits data from and to a mobile terminal configured for electronic payment, for example through the use of an electronic version of the payment instrument, like a digital wallet which stores one or more credit or debit cards in electronic form. The NFC transceiver may also be used not only to facilitate such digital wallet payment, but also receive data used in a value added service transaction initiated by the mobile terminal, wherein such data is typically sent to the POS terminal for further processing. The payment terminal may be a standalone device or may be connected to the POS terminal. The POS terminal is a system that may include a computer, a cash register and other equipment that supports functions like inventory management and integration with a merchant backend system. In one implementation, the POS terminal captures a subset of the transaction purchase data such as details of services or goods purchased (e.g. each purchased grocery item, each provided medical service and their respective cost) when these purchases are scanned by the POS terminal at the point of payment and generates a receipt number for the purchase. The payment terminal captures another subset of the transaction purchase, such as the total cost of the purchase and details of the payment instrument (such as a primary account number (PAN) of a credit card or debit card) used to make the purchase. In another implementation, the payment interface may be an integrated system, so that it captures all transaction purchase data generated when making a purchase on a payment instrument, such transaction purchase data including itemised detail of the purchase, the PAN of the payment instrument, the receipt number for the purchase and the transaction number generated from using the payment instrument for the purchase.

The payment network, to which the intermediary terminal is connected, refers to a network of computers which route and process electronic transaction messages when making electronic payment using a payment instrument. The network of computers may thus include computer systems used to implement the four party model used by Visa® or MasterCard® to process a payment transaction made using their card. The notable (but not necessarily only) components of the payment network thus include an acquirer, an issuer and a switch that routes information between the acquirer and the issuer. In the four party model, the acquirer is called so because it ‘acquires’ transaction information from a merchant or retailer from which purchases are made. The issuer is so called, because it is the entity that has ‘issued’ the payment instrument on which the purchases are made.

This intermediary terminal serves to provide the necessary infrastructure to allow the digital receipt to be transmitted to one or more electronic addresses. The data that this infrastructure requires to facilitate such transmission is explained in detail below with reference to steps 102, 104, 106, 108 and 109 of the method 100.

In step 102, transaction purchase data of purchases made via the payment interface is received from the payment interface. Transaction purchase data comprises data generated during a transaction for purchase of goods and/or services, wherein the generated data comprises any one or more of a receipt number of the transaction; cost of the transaction; and itemisation of the purchased goods and/or services. The transaction is typically initiated by use of a payment instrument to purchase goods and/or services. The transaction purchase data is received by the intermediary terminal, so that the intermediary terminal is provided with details of the purchase made at a merchant or retail store. Details of the payment instrument on which the purchases are made at the payment interface are also received by the intermediary terminal, such details including any one or more of a primary account number (PAN), an issuer identification number (IIN) or banking identification number (BIN) of the payment instrument. The details of the payment instrument are received by the intermediary terminal, so that the intermediary terminal can relay them to the payment network in order to obtain personal detail data of the account holder of the payment instrument. This personal detail data is processed by the intermediary terminal in the step 109 to send an electronic receipt of the purchased goods and/or services to the account holder.

In step 104, the intermediary terminal transmits to the payment network, details of the payment instrument on which the purchases are made. Upon receipt of the details of the payment instrument, the payment network will effect a process to obtain the personal detail data of the account holder of the payment instrument.

Personal detail data includes personal information of the account holder, such as his or her name and address, contact details (such as mobile number) and a preferred mode of receiving an electronic receipt of purchases made. This preferred mode provides one or more electronic addresses on which the account holder has indicated the electronic receipt is to be received. Such personal detail data is typically kept by an issuer of the payment instrument. Thus, in one implementation of the process to obtain the personal detail data of the account holder of the payment instrument, the payment instrument details (such as its PAN, IIN or BIN) is analysed against an account holder database to identify the account holder of the payment instrument, where the account database is hosted at an issuer of the payment instrument. With the account holder identified, his or her personal detail data can be retrieved. The issuer may then provide this personal detail data to the payment network as part of packet data that is exchanged between the payment network and the issuer when implementing the method 100. The intermediary terminal will then receive, from the payment network, the personal detail data of the payment instrument on which the purchases are made in step 106.

In step 108, the intermediary terminal generates an electronic receipt from the received transaction purchase data and the received personal detail data. In one implementation, the intermediary terminal requires receipt of the transaction purchase data from which data such as itemised details of purchased goods or service are extracted to populate the electronic receipt. The intermediary terminal also requires receipt of the received personal detail data from which is extracted the preferred mode in which the electronic receipt is to be sent to the account holder of the payment instrument.

In step 109, the intermediary terminal transmits the electronic receipt to at least one electronic address. The at least one electronic address is determined from the personal detail data received by the intermediary terminal in the step 106. The electronic address may for example be a mobile terminal such as a smart phone with an advanced mobile operating system, such as iOS of Apple Inc. or Android of Google Inc. The operating system may host one or more applications, where one or more of these applications may be used to receive the transmitted electronic receipt, whereby the electronic receipt is in application specific format, i.e. configured in a format that is compatible to the design of the application. The mobile terminal may also receive the digital receipt in short message (SMS) format. Alternatively, the electronic address may be an email server to which the electronic receipt is sent in email format, whereby the email is retrieved, for example, by logging in using a mobile terminal or a computer terminal.

From the above, generation and transmission of the electronic receipt requires personal detail data held by an issuer of a payment instrument on which purchases are made; and transaction purchase data held by a payment interface from which the purchases are processed. The issuer of the payment instrument and the payment interface each operate separate and independent systems, so that a platform is required to host the personal detail data and the transaction purchase data in order to generate an electronic receipt for the purchases and transmit the electronic receipt to an intended destination. The intermediary terminal provides such a platform that can host implementation of the method 100.

The generation of the electronic receipt in step 106 may include the further step of itemising the electronic receipt from the received transaction purchase data, whereby the transmission of the electronic receipt involves transmitting the itemised electronic receipt. In one implementation, the itemised electronic receipt lists each purchased good or service and its respective cost on a separate line entry. This provides the account holder of the payment instrument full details of any transaction made on the payment instrument. In contrast, printed receipts issued by a payment terminal which does not use the method 100 of FIG. 1 only indicate the total cost of a transaction.

The generation of the electronic receipt in step 108 may also further include the steps of detecting a transmission format with which the electronic receipt is to be transmitted to the at least one electronic address; and applying an optimal layout arrangement on the electronic receipt in response to the detected format. Exemplary transmission formats include any one or more of application specific (i.e. the receipt is sent in a format that is accessible by an application specifically designed to receive the electronic receipt), short message service (SMS) or email. In addition, generation of the electronic receipt in step 106 may occur in response to receiving a request for the electronic receipt. This allows the electronic receipt to be readily available at any instance and solves the problem of misplacing receipts.

The method 100 may further comprise allocating a pairing identifier to the transaction purchase data. This allocation may have the pairing identifier combined with the transaction purchase data and is unique, so that the pairing identifier provides a means to retrieve a particular transaction purchase data. The pairing identifier may be subsequently used to initiate generation of the electronic receipt, i.e. the intermediary terminal will use this pairing identifier to generate the electronic receipt.

In one implementation, the pairing identifier is generated at the payment interface, wherein the pairing identifier is generated after detection of use of the payment instrument to make the purchases. In such an implementation, receipt of the transaction purchase data from the payment interface in step 102 includes receipt of the pairing identifier. Receipt of the personal detail data in the intermediary terminal at step 104 then occurs after receipt of the transaction purchase data and the pairing identifier. The intermediary terminal then generates the electronic receipt after receipt of the personal detail data and in response to the pairing identifier, which is extracted from the data packet that contains the transaction purchase data and the pairing identifier.

The personal detail data may be received from an issuer of the payment instrument and as mentioned above, this personal detail data may first be routed through the payment network before it reaches the intermediary terminal.

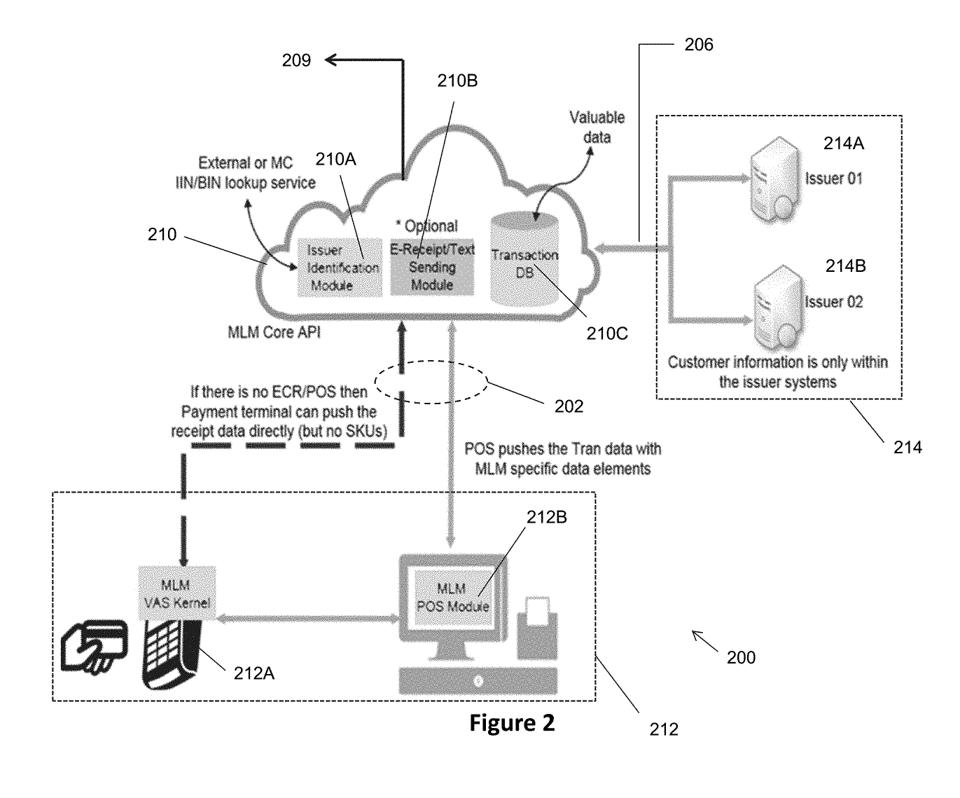

FIG. 2 shows an overview of a system 200 which operates in accordance with the method of FIG. 1.

The system 200 has an intermediary terminal 210 connected to a payment interface 212 and a payment network 214.

The intermediary terminal 210 has several modules, of which only an issuer identification module 210A, an electronic receipt transmission module 210B and a transaction database module 210C are shown. It will be appreciated that other modules of the intermediary terminal 210 are not shown for the purpose of simplicity.

The issuer identification module 210A communicates mainly with the payment interface 212 and the payment network 214. The issuer identification module 210A receives 202 details of a payment card (e.g. its identification data, such as issuer identification number (IIN), bank identification number (BIN) or PAN) used to purchase services or goods at the payment interface 212. The issuer identification module 210A identifies which of the issuers 214A, 214B has issued the payment card from the received payment card details. The issuer identification module 210A then communicates with the identified issuer 214A, 214B to receive 206 personal detail data of the account holder of the payment card. In this manner, the intermediary terminal 210 receives 206, from the payment network 214, personal detail data of an account holder of the payment instrument on which the purchases are made. The issuer identification module 210A also receives 202 transaction purchase data of purchases made at the payment interface 212.

The payment card details are typically sent by a payment terminal 212A of the payment interface 212, while the transaction purchase data is sent by a POS terminal 212B of the payment interface 212. However, in another implementation, the payment terminal 212A may integrate hardware that supports both cash register and payment instrument functions, whereby the payment terminal 212A can push the transaction purchase data to the electronic receipt transmission module 210B, without requiring input from the cash register module of the POS terminal 212B.

The electronic receipt transmission module 210B generates the electronic receipt from the transaction purchase data and the personal detail data both received by the intermediary terminal 210. As part of the undertaken steps to generate this electronic receipt, the electronic receipt transmission module 210B processes the received personal detail data to extract details of at least one electronic address to which an electronic receipt should be transmitted. The electronic receipt transmission module 210B can then transmit 209 an electronic receipt to the at least one electronic address, from which the account holder of the payment instrument can access to retrieve the transmitted electronic receipt.

The transaction database module 210C stores data which is used during execution of the method of FIG. 1, such as the payment card details, the transaction purchase data and the personal detail data.

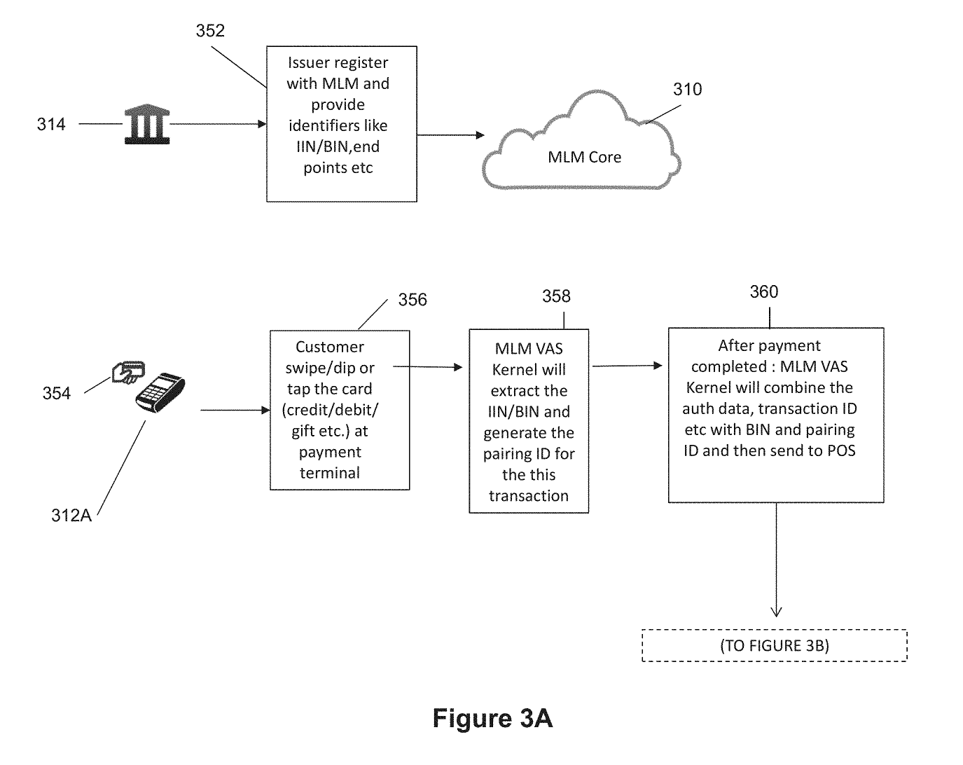

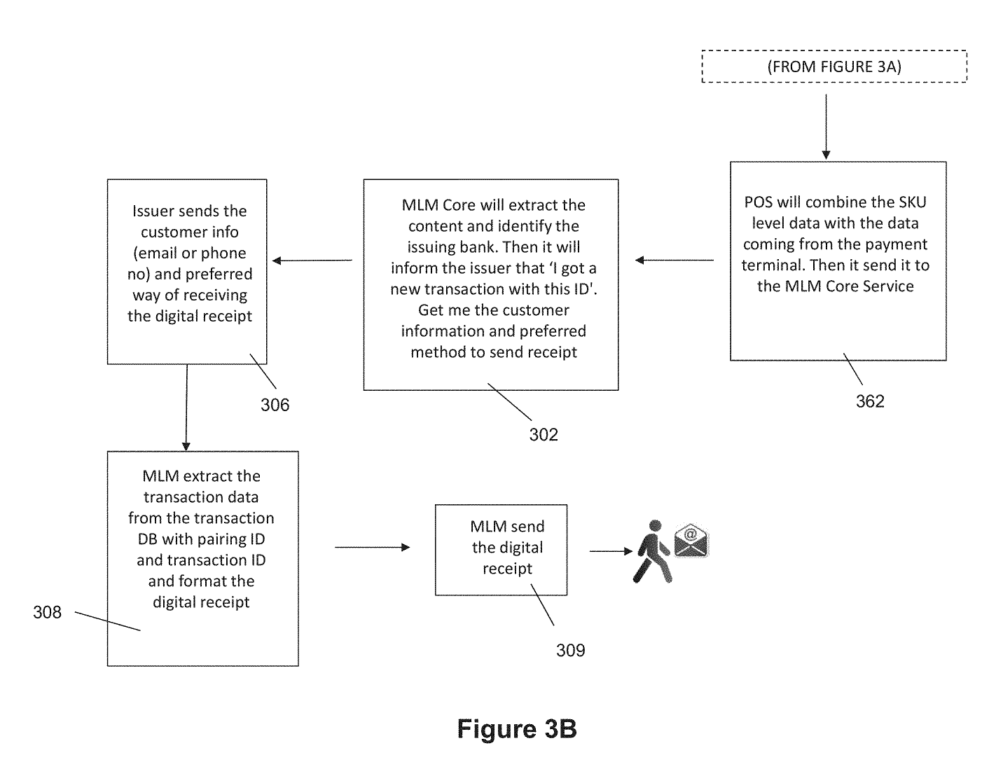

One possible implementation of the method 100 of FIG. 1 is described below with reference to FIGS. 3A and 3B.

In step 352, an issuer 314 belonging to a payment network registers with the intermediary terminal 310 by providing payment card 354 details, such as the IIN/BIN of the payment card 354. Further data that the issuer 314 may provide includes end points, which may be, for example, a pointer to a web service with data resources to support the method 100 shown in FIG. 1. In one implementation, the registration is performed through a cloud computing network to which the intermediary terminal 310 belongs. The payment card 354 details and the end point data may be stored in the transaction database module 210C (refer FIG. 2) of the intermediary terminal 310.

In step 356, a customer uses a payment instrument 354 (such as a credit card/debit card/gift card) on a payment terminal 312A to make payment. This may be done by swiping or tapping the payment instrument 354 at the payment terminal 312A. The payment terminal 312A is part of a payment interface, the payment interface being not shown for the sake of simplicity.

In step 358, a kernel of the payment terminal 312A will extract the payment card 354 details (such as its IIN/BIN) from the data received from the payment terminal 312A. The intermediary terminal 310 will then generate a pairing identifier for the transaction made using the payment instrument 354. The pairing identifier is then allocated to this transaction. As mentioned above, the pairing identifier provides a means to retrieve a particular transaction purchase. In the implementation shown in step 358, the pairing identifier is generated in response to receiving the payment card 354 details. In another implementation where the payment terminal 312A also has transaction purchase data, such as a receipt number of the transaction; cost of the transaction and itemisation of the purchased goods and/or services, the pairing identifier may be allocated to the transaction purchase data.

In step 360, after the payment transaction is completed, the kernel of the intermediary terminal 310 will combine authorisation data (such as a message from the issuer 314 that provides a number that can positively identify the authorised transaction), transaction ID, the IIN/BIN of the payment instrument 354 and the pairing identifier of step 358. This first set of combined data will be sent to a POS of the payment interface to which the payment terminal 312A belongs.

In step 362, the POS will combine shop keeper unit (SKU) level data with the data sent by the intermediary terminal 310 in step 360. The SKU data includes transaction purchase data like the items (such as goods and/or services) that have been purchased. Thus, the POS will also include transaction purchase data into this second set of combined data. This second set of combined data is sent to the intermediary terminal 310.

In step 302, the intermediary terminal 310 will extract content from this second set of combined data to identify the issuer 314 of the payment instrument 354. Since the second set of combined data also contains transaction purchase data, in step 302 the intermediary terminal 310 receives, from the payment interface, transaction purchase data of purchases made at the payment interface. The transaction purchase data, along with its pairing identifier allocated in step 358, may be stored in the transaction database module 210C (refer FIG. 2) of the intermediary terminal 310. The intermediary terminal 310 will then inform the issuer 314 that the intermediary terminal 310 has a new transaction with the transaction ID (see step 360) and request from the issuer 314 a preferred way in which the customer would like to receive an electronic receipt of purchases made at the payment interface.

The preferred way to receive an electronic receipt is typically found from personal detail data that an account holder of the payment instrument 354 provides when, for example, signing up for the payment instrument 354. Thus, at step 306, the personal detail data of the account holder of the payment instrument 354 is sent by the issuer 314 to the intermediary terminal 310. The intermediary terminal 310 may receive this personal detail data from the payment network to which the issuer 314 belongs.

In step 308, the intermediary terminal 310 will retrieve, from its transaction database module 210C (refer FIG. 2), the transaction purchase data of the purchases made using the payment instrument 354. This retrieval may be performed, for example, using the transaction ID (see step 306) and/or the pairing identifier. The intermediary terminal 310 will then generate an electronic receipt from the transaction purchase data and the personal detail data. The intermediary terminal 310 may then analyse the personal detail data to determine one or more devices to which the electronic receipt is to be sent, so as to detect a transmission format with which the electronic receipt is to be transmitted to the at least one electronic address. This is so as to apply an optimal layout arrangement on the electronic receipt in response to the detected format, which facilitates viewing of the electronic receipt in the device used to access the electronic receipt.

At step 309, the intermediary terminal 310 will transmit the digital receipt, formatted as set out in step 306, to at least one electronic address, the at least one electronic address being determined from the received personal detail data.

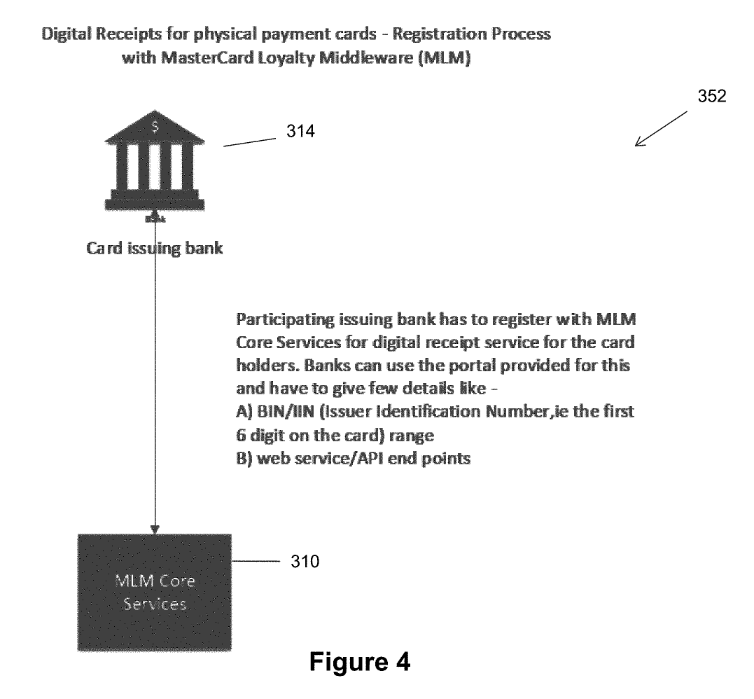

FIG. 4 shows the registration process of step 352 of FIGS. 3A and 3B. This registration is required in order for the issuer 314 to avail itself to the electronic receipt service provided by to be issued in accordance with the method 100 shown in FIG. 1.

Registration may be done through a portal accessed by the issuer 314. Details which the issuer 314 has to provide, through the portal, to the intermediary terminal 310 are the BIN/IIN range reserved for the system 200 and data of web service/API end points, such as web services with data resources described above in conjunction with step 352.

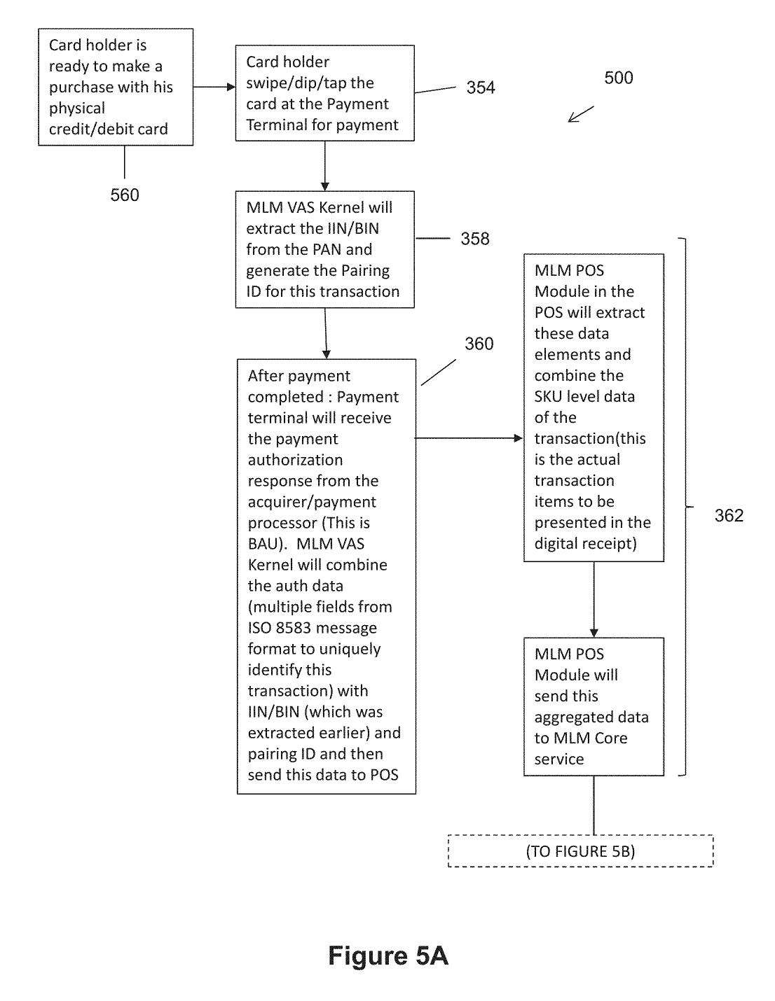

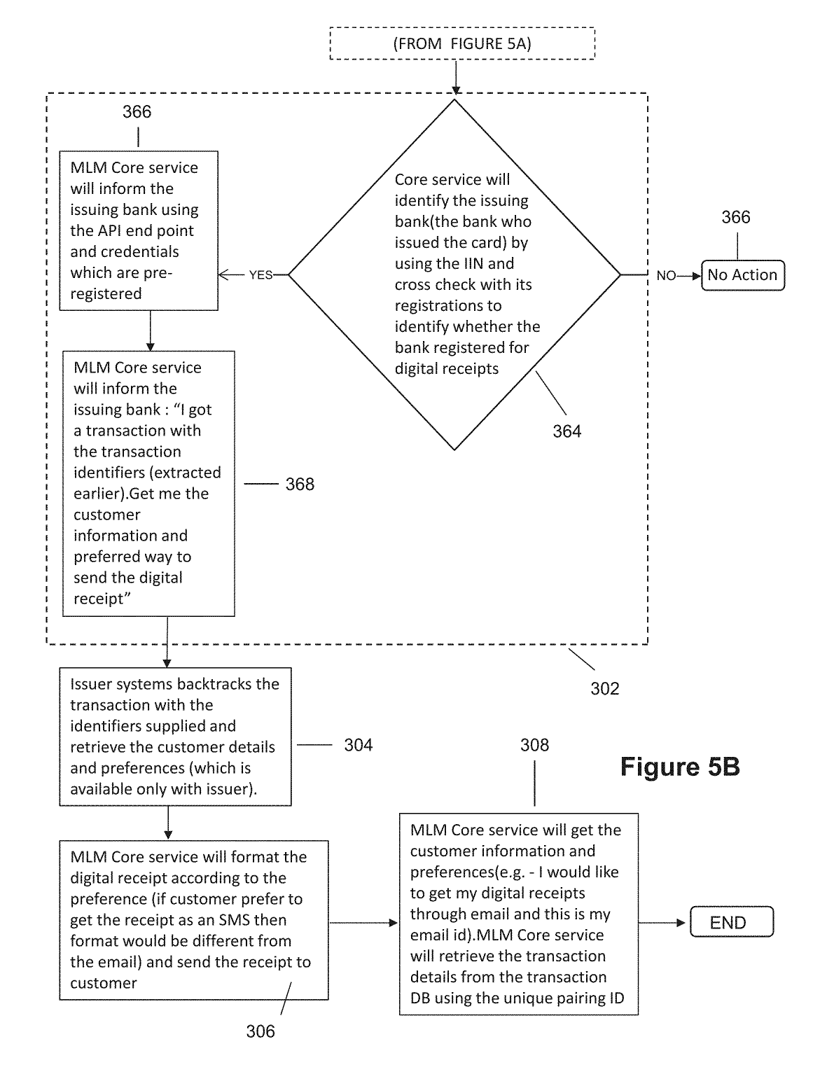

FIGS. 5A and 5B show a flowchart 500 for implementing the method 100 shown in FIG. 1. FIGS. 5A and 5B are described below with reference to FIGS. 3A and 3B.

The flowchart 500 begins at step 560, where a cardholder is ready to make purchases using a payment instrument. As explained with respect to FIGS. 3A and 3B, the payment instrument is used on a payment terminal that is connected to an intermediary terminal, such as the intermediary terminal 210 described with reference to FIG. 2.

Steps 354 and 358 have already been described above with respect to FIGS. 3A and 3B and are therefore not further elaborated. FIGS. 5A and 5B illustrate that the authorisation data of step 360 refers to a response received by the payment terminal from communicating with a payment network (such as MasterCard's four party system) to authorise payment using a payment card. The authorisation data will be combined with the IIN/BIN data and the pairing identifier obtained in step 358, and sent to the POS.

As for processing that occurs after step 362, FIGS. 5A and 5B illustrate that in step 364, IIN details extracted from the data sent by the POS to the intermediary terminal will be used to determine whether the IIN details can be located in the IIN data range stored in the intermediary terminal. The inability to locate a match signifies that the issuer has not registered for the electronic receipt service, whereby no action is taken in step 366, i.e. no electronic receipt will be sent to the cardholder. If a match is found, the intermediary terminal will then in step 366 initiate communication with the issuer through API end point and credentials provided to the intermediary terminal during the registration that occurred in step 352 of FIGS. 3A and 3B. This communication is to send a request in step 368 to the issuer for the personal detail data of the cardholder, which allows the intermediary terminal to determine a preferred way to which the cardholder would like to receive the electronic receipt.

In step 304, the issuer will relocate the transaction for which authorisation data had already been sent in step 360. This relocation is performed, for example, by the identifiers sent by the intermediary terminal to the issuer, such as the transaction ID. Once the transaction is identified, the personal detail data of the cardholder is sent by the issuer to the intermediary terminal, as described above with reference to FIGS. 3A and 3B.

The remaining steps 306 and 308 have already been described above with respect to FIGS. 3A and 3B and are therefore not further elaborated.

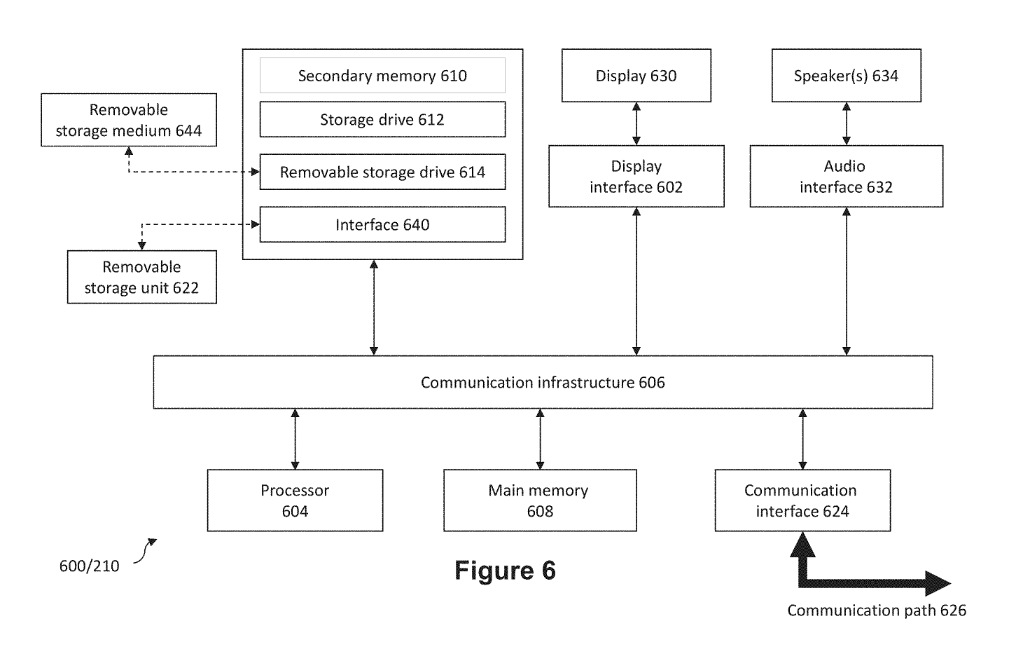

FIG. 6 depicts an exemplary computing device 600, hereinafter interchangeably referred to as a computer system 600, where one or more such computing devices 600 may be used to execute the method described in FIG. 1 for allowing for transmission of an electronic receipt from an intermediary terminal connected to a payment interface and a payment network. The following description of the computing device 600 is provided by way of example only and is not intended to be limiting.

As shown in FIG. 6, the example computing device 600 includes a processor 604 for executing software routines. Although a single processor is shown for the sake of clarity, the computing device 600 may also include a multi-processor system. The processor 604 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a storage drive 612, which may be a hard disk drive, a solid state drive or a hybrid drive and/or a removable storage drive 614, which may include a magnetic tape drive, an optical disk drive, a solid state storage drive (such as a USB flash drive, a flash memory device, a solid state drive or a memory card), or the like. The removable storage drive 614 reads from and/or writes to a removable storage medium 644 in a well-known manner. The removable storage medium 644 may include magnetic tape, optical disk, non-volatile memory storage medium, or the like, which is read by and written to by removable storage drive 614. As will be appreciated by persons skilled in the relevant art(s), the removable storage medium 644 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 640. Examples of a removable storage unit 622 and interface 640 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 622 and interfaces 640 which allow software and data to be transferred from the removable storage unit 622 to the computer system 600.

The computing device 600 also includes at least one communication interface 624. The communication interface 624 allows software and data to be transferred between computing device 600 and external devices via a communication path 626. In various embodiments of the inventions, the communication interface 624 permits data to be transferred between the computing device 600 and a data communication network, such as a public data or private data communication network. The communication interface 624 may be used to exchange data between different computing devices 600 which such computing devices 600 form part an interconnected computer network. Examples of a communication interface 624 can include a modem, a network interface (such as an Ethernet card), a communication port (such as a serial, parallel, printer, GPIB, IEEE 1394, RJ45, USB), an antenna with associated circuitry and the like. The communication interface 624 may be wired or may be wireless. Software and data transferred via the communication interface 624 are in the form of signals which can be electronic, electromagnetic, optical or other signals capable of being received by communication interface 624. These signals are provided to the communication interface via the communication path 626.

As shown in FIG. 6, the computing device 600 further includes a display interface 602 which performs operations for rendering images to an associated display 630 and an audio interface 632 for performing operations for playing audio content via associated speaker(s) 634.

As used herein, the term “computer program product” may refer, in part, to removable storage medium 644, removable storage unit 622, a hard disk installed in storage drive 612, or a carrier wave carrying software over communication path 626 (wireless link or cable) to communication interface 624. Computer readable storage media refers to any non-transitory, non-volatile tangible storage medium that provides recorded instructions and/or data to the computing device 600 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 624. Such computer programs, when executed, enable the computing device 600 to perform one or more features of embodiments discussed herein. In various embodiments, the computer programs, when executed, enable the processor 604 to perform features of the above-described embodiments. Accordingly, such computer programs represent controllers of the computer system 600.

Software may be stored in a computer program product and loaded into the computing device 600 using the removable storage drive 614, the storage drive 612, or the interface 640. Alternatively, the computer program product may be downloaded to the computer system 600 over the communications path 626. The software, when executed by the processor 604, causes the computing device 600 to perform the method as described in FIG. 1.

It is to be understood that the embodiment of FIG. 6 is presented merely by way of example. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

It will be appreciated that the elements illustrated in FIG. 6 function to provide means for performing the method as described with respect to FIG. 1. For example, the computing device 600 may be used to realise the intermediary terminal 210 shown in FIG. 2. As described above with respect to FIG. 2, the intermediary terminal 210 is connected to a payment interface 212 and a payment network 214. The intermediary terminal 210 comprises: at least one processor 604 and at least one memory 608 including computer program code. The intermediary terminal 210 also includes a cashier port in electrical communication with the payment interface 212; a network port in electrical communication with the payment network 214; and a transmission port. The cashier port, the network port and the transmission port are realised by the communication interface 624 shown in FIG. 6.

The at least one memory 608 and the computer program code are configured to, with the at least one processor 604, cause the intermediary terminal 210 at least to: receive, through the cashier port, transaction purchase data of purchases made at the payment interface 212 and details of a payment instrument on which the purchases are made. The intermediary terminal 210 is further configured to receive, through the network port, personal detail data of an account holder of the payment instrument on which the purchases are made. The intermediary terminal 210 then generates an electronic receipt from the received transaction purchase data and the received personal detail data and transmits, through the transmission port, an electronic receipt to at least one electronic address. The at least one electronic address is determined from the received personal detail data.

Generation of the electronic receipt may include itemising the electronic receipt from the received transaction purchase data. The transmission of the electronic receipt then transmits the itemised electronic receipt. Generation of the electronic receipt may further include detecting a transmission format with which the electronic receipt is to be transmitted to the at least one electronic address. An optimal layout arrangement may then be applied on the electronic receipt in response to the detected format. The transmission format may be any one or more of application specific format, short message service (SMS) or email.

In one implementation, the intermediary terminal 210 may be further configured to receive, through the cashier port, a pairing identifier allocated to the transaction purchase data. The pairing identifier is used to initiate generation of the electronic receipt. The intermediary terminal 210 may then be further configured to receive the personal detail data after receipt of the transaction purchase data and the pairing identifier and generate the electronic receipt after receipt of the personal detail data and utilisation of the pairing identifier.

Receipt of the personal detail data by the intermediary terminal 210 may include receiving the personal detail data from an issuer of the payment instrument. In addition, generation of the electronic receipt may occur in response to receiving a request for the electronic receipt.

In another implementation, the unique identifier is received from the receiving terminal 214, such as described in FIGS. 2 and 4.

The computing device 600 of FIG. 6 may execute the method shown in FIG. 1 when the computing device 600 executes instructions which may be stored in any one or more of the removable storage medium 644, the removable storage unit 622 and storage drive 612. These components 622, 644 and 612 provide a non-transitory computer readable medium having stored thereon executable instructions for controlling the intermediary terminal 210, realised by the computing device 600, to perform steps comprising: a) receive, through a cashier port, transaction purchase data of purchases made via a payment interface to which the intermediary terminal 210 is connected and details of a payment instrument on which the purchases are made; b) transmit, through a network port, details of the payment instrument; c) receive, through a network port, personal detail data of an account holder of the payment instrument on which the purchases are made; d) generate an electronic receipt from the received transaction purchase data and the received personal detail data; and e) transmit, through a transmission port, an electronic receipt to at least one electronic address, the at least one electronic address being determined from the received personal detail data.

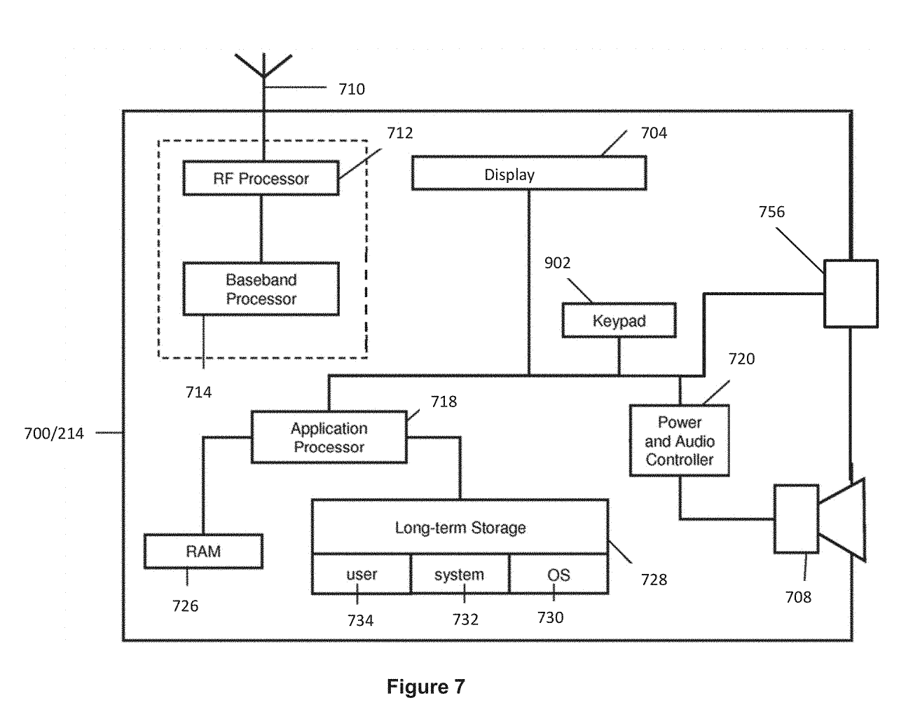

FIG. 7 is a schematic of a computing device 700 that may be utilized to implement the payment interface 212 shown in FIG. 2.

The computing device 700 comprises a keypad 702, a display 704, a speaker 708 and an antenna 710. Communication hardware that is used to enable NFC communication is represented by RF processor 712 which provides an RF signal to the antenna 710 for the transmission of data signals, and the receipt therefrom. Additionally provided is a baseband processor 714, which provides signals to and receives signals from the RF Processor 712.

The keypad 702 and the display 704 are controlled by an application processor 718. The display 704 is used to provide an indication of the status of the payment interface 212, such as payment options available when the payment interface 212 detects that it is being used to receive electronic payment or that the payment interface 212 is processing payment after a payment option is selected through the keypad 702, A power and audio controller 720 is provided to supply power to the RF processor 712 and the baseband processor 714, the application processor 718, and other hardware. The power and audio controller 720 also controls audio output via the speaker 708. The speaker 708 is used to provide sounds to indicate that a data transaction with the payment interface 212 has been successfully completed.

In order for the application processor 718 to operate, various different types of memory are provided. Firstly, the computing device 700 includes Random Access Memory (RAM) 726 connected to the application processor 718 into which data and program code can be written and read from at will. Code placed anywhere in RAM 726 can be executed by the application processor 718 from the RAM 726. RAM 726 represents a volatile memory of the computing device 700.

Secondly, the computing device 700 is provided with a long-term storage 728 connected to the application processor 718. The long-term storage 728 comprises three partitions, an operating system (OS) partition 730, a system partition 732 and a user partition 734. The long-term storage 728 represents a non-volatile memory of the computing device 700.

In the present example, the OS partition 730 contains the firmware of the computing device 700 which includes an operating system. Other computer programs may also be stored on the long-term storage 728, such as application programs, and the like. In particular, application programs which are mandatory to the computing device 700 are typically stored in the system partition 732. The application programs stored on the system partition 732 would typically be those which are bundled with the computing device 700 by the device manufacturer when the computing device 700 is first sold. Application programs which are added to the computing device 700 by the user would usually be stored in the user partition 734.

The payment interface 212 is configured to be in in electrical communication with an intermediary terminal, which is configured to generate and transmit an electronic receipt. The payment interface 212 is in electrical communication with the intermediary terminal through a transmission port 756. The at least one processor (e.g. application processor 718) and the at least one memory (e.g. RAM 726, long-term storage 728) with its computer program code are configured to cause the payment interface 212 at least to detect use of a payment instrument to make purchases. The at least one memory and the computer program code are further configured to, with the at least one processor, generate a pairing identifier used to initiate generation of the electronic receipt of the purchases made and transmit, through the transmission port, the pairing identifier to the intermediary terminal.

The payment interface 212 of FIG. 7 may execute the method shown in FIG. 1 when the payment interface 212 executes instructions which may be stored in any one or more of the RAM 726 or the long-term storage 728. These components 726 and 728 provide a non-transitory computer readable medium having stored thereon executable instructions for controlling the payment interface 212 to perform steps comprising: a) detecting use of a payment instrument to make purchases; b) generating a pairing identifier used to initiate generation of the electronic receipt of the purchases made; and c) transmitting, through a transmission port, the pairing identifier to the intermediary terminal.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for transmitting an electronic receipt from an intermediary terminal connected to a payment interface and a payment network, the method comprising:
receiving, from the payment interface, transaction purchase data of purchases made via the payment interface and details of a payment instrument on which the purchases are made;
transmitting, to the payment network, details of the payment instrument;
receiving, from the payment network, personal detail data of an account holder of the payment instrument;
generating an electronic receipt from the received transaction purchase data and the received personal detail data; and
transmitting the electronic receipt to at least one electronic address, the at least one electronic address being determined from the received personal detail data.

2. The method of claim 1, wherein the generation of the electronic receipt comprises itemising the electronic receipt from the received transaction purchase data; and the transmission of the electronic receipt comprises transmitting the itemised electronic receipt.

3. The method of claim 1, wherein the generation of the electronic receipt further comprises
detecting a transmission format with which the electronic receipt is to be transmitted to the at least one electronic address; and
applying an optimal layout arrangement on the electronic receipt in response to the detected format.

4. The method of claim 3, wherein the transmission format comprises any one or more of an application specific format, short message service (SMS) or email.

5. The method of claim 1, further comprising
allocating a pairing identifier to the transaction purchase data, the pairing identifier used to initiate generation of the electronic receipt.

6. The method of claim 5, wherein the pairing identifier is generated at the payment interface and wherein the pairing identifier is generated after detection of use of the payment instrument to make the purchases.

7. The method of claim 5, wherein receipt of the transaction purchase data includes receipt of the pairing identifier.

8. The method of claim 7, wherein
receipt of the personal detail data occurs after receipt of the transaction purchase data and the pairing identifier; and
wherein generation of the electronic receipt occurs after receipt of the personal detail data and in response to the pairing identifier.

9. The method of claim 1, wherein receipt of personal detail data comprises receiving the personal detail data from an issuer of the payment instrument.

10. The method of claim 1, wherein the payment interface comprises any one or more of a payment terminal or a POS (point of sale) terminal.

11. The method of claim 1, wherein the transaction purchase data comprises data generated during a transaction for purchase of goods and/or services, wherein the generated data comprises any one or more of a receipt number of the transaction; cost of the transaction; and itemisation of the purchased goods and/or services.

12. The method of claim 1, wherein generation of the electronic receipt occurs in response to receiving a request for the electronic receipt.

13. An intermediary terminal adapted to connect to a payment interface and a payment network, the intermediary terminal comprising:
at least one processor;
at least one memory including computer program code;
a cashier port in electrical communication with the payment interface;
a network port in electrical communication with the payment network; and
a transmission port,
the at least one memory and the computer program code configured to, with the at least one processor, cause the intermediary terminal at least to:
receive, through the cashier port, transaction purchase data of purchases made at the payment interface and details of a payment instrument on which the purchases are made;
receive, through the network port, personal detail data of an account holder of the payment instrument;
generate an electronic receipt from the received transaction purchase data and the received personal detail data; and
transmit, through the transmission port, an electronic receipt to at least one electronic address, the at least one electronic address being determined from the received personal detail data.

14. The intermediary terminal of claim 13, wherein the generation of the electronic receipt comprises itemising the electronic receipt from the received transaction purchase data and the transmission of the electronic receipt comprises transmitting the itemised electronic receipt.

15. The intermediary terminal of claim 13, wherein the generation of the electronic receipt further comprises
detecting a transmission format with which the electronic receipt is to be transmitted to the at least one electronic address; and
applying an optimal layout arrangement on the electronic receipt in response to the detected format.

16. The intermediary terminal of claim 15, wherein the transmission format comprises any one or more of application specific format, short message service (sms) or email.

17. The intermediary terminal of claim 13, wherein the intermediary terminal is further configured to
receive, through the cashier port, a pairing identifier allocated to the transaction purchase data, the pairing identifier used to initiate generation of the electronic receipt.

18. The intermediary terminal of claim 17, wherein the intermediary terminal is further configured to
receive the personal detail data after receipt of the transaction purchase data and the pairing identifier; and
generate the electronic receipt after receipt of the personal detail data and utilisation of the pairing identifier.

19. The intermediary terminal of claim 13, wherein receipt of the personal detail data comprises receiving the personal detail data from an issuer of the payment instrument.

20. The intermediary terminal of claim 13, wherein generation of the electronic receipt occurs in response to receiving a request for the electronic receipt.

21. A payment interface in electrical communication with an intermediary terminal, the intermediary terminal configured to generate and transmit an electronic receipt, the payment interface comprising:
at least one processor; and
at least one memory including computer program code; and
a transmission port in electrical communication with the intermediary terminal,
the at least one memory and the computer program code configured to, with the at least one processor, cause the payment interface at least to:
detect use of a payment instrument to make purchases;
generate a pairing identifier used to initiate generation of the electronic receipt of the purchases made; and
transmit, through the transmission port, the pairing identifier to the intermediary terminal.

22. A non-transitory computer readable medium having stored thereon executable instructions for controlling an intermediary terminal, adapted to connect to a payment interface and a payment network, to perform steps comprising
receive, through a cashier port, transaction purchase data of purchases made via the payment interface and details of a payment instrument on which the purchases are made;
transmit, through a network port, details of the payment instrument;
receive, through the network port, personal detail data of an account holder of the payment instrument;
generate an electronic receipt from the received transaction purchase data and the received personal detail data; and
transmit, through a transmission port, an electronic receipt to at least one electronic address, the at least one electronic address being determined from the received personal detail data.

23. A non-transitory computer readable medium having stored thereon executable instructions for controlling a payment interface, the payment interface in electrical communication with an intermediary terminal configured to generate and transmit an electronic receipt, to perform steps comprising
detecting use of a payment instrument to make purchases;
generating a pairing identifier used to initiate generation of the electronic receipt of the purchases made; and
transmitting, through a transmission port, the pairing identifier to the intermediary terminal.
